(19) United States
(12) Patent Application Publication
(10) Pub. No.: US 2011/0084542 A1
(43) Pub. Date: Apr. 14, 2011

(54) Vehicle wheel assembly with component cover

(76) Inventor: Vigintas Pilipavichius, Orland Park, IL (US)

(21) Appl. No.: 12/587,747

(22) Filed: Oct. 13, 2009

(51) Int. Cl. B60B 7/00

(52) U.S. Cl. 301/37.101

(57) ABSTRACT

A vehicle wheel assembly including a brake disc rotor assembly that defines an operating axis for a wheel and has a braking surface, a rotor head, an axially facing wheel mounting surface against which a wheel rim is placed, and a radially facing surface axially outward of the braking surface. A cover assembly with a wall conforms generally to the radially facing surface and is situated to block viewing of at least a part of the radially facing surface from an axial perspective.

### BACKGROUND OF THE INVENTION

1. Field of the Invention

This invention relates to vehicle wheel assemblies and, more particularly, to a cover for exposed components thereon.

2. Background Art

Automotive brake technology has advanced considerably over the last decade. In the past, engineering efforts in the automotive industry were focused primarily on engine and chassis design, while brake technology generally lagged, at least in the non-racing field. Wheel rim sizes were relatively small, with all wheel mounting and brake components blocked from view by separable hubcaps.

Developing brake technology led to larger diameter wheel rims and brake rotors and associated braking surfaces. Whereas in the past an emphasis was placed on hiding such brake components, the current trend has been to construct the vehicle wheels so that the high-tech brake components are clearly visible. This has been accomplished by making the wheel rims with relatively narrow “spokes”, with spacing therebetween defining openings through which the brake components can be viewed.

It is now common, particularly on higher end automobiles, to see exposed braking surfaces, calipers, and heads immediately inboard of the wheel mounting surface on brake disc rotors. The large diameter braking surfaces are highly prominent in this construction and, by reason of being frictionally engaged during a braking operation, remain constantly “buffed” to an appealing shiny state. The exposed rotor heads are also clearly visible and made from metal that typically is prone to unsightly rusting. This rusting can occur simply from exposure to water that may be applied as the vehicle is washed or merely parked in high humidity conditions. This rust detracts significantly from the overall aesthetics of the wheel. Further, potential consumers, unfamiliar with automotive technology, may consider the rust buildup to signify that a rotor is of low quality and/or defective.

Because of the above problems, a number of cover systems have been devised with the intent of improving aesthetics in an open wheel design. Typically, these covers function similarly to the conventional hubcap but reside between the wheel and the mounting structure therefor. Generally, these cover designs defeat the objective of an open wheel design by reason of blocking from view high-tech brake components that manufacturers wish to prominently display to users and prospective purchasers to promote their product and constantly evolving technology.

Additionally, it is common for these covers to be mounted by forming integrally therewith a wall that becomes captive between the wheels and rotor heads at a location where the wheel mounting bolts are situated. This mounting method introduces a number of potential problems.

First of all, if the cover is made from a plastic material that is prone to cracking, secure fastening of a wheel through the mounting bolts may squeeze a captive wall to the point that cracks are generated and/or propagate. This condition could lead to the generation of an unsightly cover. Alternatively, this cracking may ultimately cause a part of the cover to break free from the wheel.

Additionally, the use of a non-metal wall on the cover could conceivably compromise the connection of the wheel to the drum. Whereas a conventionally mounted wheel uses metal-to-metal contact between the wheel and supporting rotor head, the interposition of a lower friction, non-metal material may compromise the wheel mount by allowing relative movement between the wheel rim and rotor.

It is believed that the above problems have prevented the automotive industry from adopting cover technology on a high-volume basis, either as original equipment or as an after market accessory. The desirability of these covers exists to this day.

### SUMMARY OF THE INVENTION

In one form, the invention is directed to a vehicle wheel assembly including a brake disc rotor assembly which defines an operating axis for a wheel and includes a braking surface, a rotor head, an axially facing wheel mounting surface against which a wheel rim is placed, and a radially facing surface axially outward of the braking surface. A cover assembly with a wall conforms generally to the radially facing surface and is situated to block viewing of at least a part of the radially facing surface from an axial perspective.

In one form, the radially facing surface resides between the braking surface and wheel mounting surface.

In one form, the cover assembly extends substantially fully axially between the braking surface and wheel mounting surface.

In one form, the wall has an inside surface that abuts to the radially facing surface.

In one form, the wall is press fit and frictionally maintained upon the brake disc rotor assembly.

In one form, the wall is captively maintained between the brake disc rotor assembly and a wheel rim operatively mounted upon the brake disc rotor assembly.

In one form, the radially facing surface has a contour between the braking surface and the wheel mounting surface, the wall has an inside surface, and the inside surface closely conforms to the contour of the radially facing surface over a majority of an axial extent of the radially facing surface between the braking surface and the wheel mounting surface.

In one form, the inside surface closely conforms to the contour of the radially facing surface over substantially the entirety of the axial extent of the radially facing surface between the braking surface and the wheel mounting surface.

In one form, the inside surface directly contacts the radially facing surface over a substantial axial extent of the radially facing surface.

In one form, a portion of the cover assembly resides captively between the wheel mounting surface and a wheel rim mounted operatively upon the brake disc rotor assembly.

In one form, the wall has a cup-shaped configuration opening axially inwardly.

In one form, the cover assembly is formed in one piece.

In one form, the wall is made from a non-metallic material.

In one form, the vehicle wheel assembly is provided in combination with a wheel rim operatively mounted upon the brake disc rotor assembly.

In one form, there are no fasteners that extend into or through the wall to maintain the wall upon the brake disc assembly.

In one form, the cover assembly substantially fully blocks viewing of the radially facing surface from an axial perspective.

In one form, the wall has a substantially uniform radial thickness between the braking surface and the wheel mounting surface.

In one form, the radially facing surface has a contour between the braking surface and the wheel mounting surface, the wall has radial inside and outside surfaces, and the outside surface conforms to the contour of the radially facing surface over a majority of the axial extent of the radially facing surface between the braking surface and the wheel mounting surface.

The invention is further directed to a vehicle wheel assembly that includes a brake disc rotor assembly which defines an operating axis for a wheel and includes a braking surface, a rotor head, an axially facing wheel mounting surface against which a wheel rim is placed, and a radially facing surface axially outward of the braking surface. A cover assembly with a wall is situated to block viewing of at least part of the radially facing surface from an axial perspective. The cover assembly does not extend radially over the wheel mounting surface, whereby it does not reside between the wheel mounting surface and a wheel rim operatively mounted upon the brake disc rotor assembly.

In one form, the radially facing surface has a contour between the braking surface and the wheel mounting surface, the wall has an inside surface, and the inside surface closely conforms to the contour of the radially facing surface over a majority of an axial extent of the radially facing surface between the braking surface and the wheel mounting surface.

### BRIEF DESCRIPTION OF THE DRAWINGS

FIG. 1 is a schematic representation of a vehicle wheel assembly including the inventive cover assembly with an associated wall that cooperates with a brake disc rotor assembly;

FIG. 2 is a cross-sectional view of one specific form of brake disc rotor assembly and cover assembly, as shown schematically in FIG. 1, with a wheel rim mounted operatively to the brake disc rotor assembly;

FIG. 3 is an elevation view of the cover assembly in FIG. 2 and showing the inside of the wall on the cover assembly;

FIG. 4 is an exploded, perspective view of the components that are assembled in FIG. 2;

FIG. 5 is a fragmentary, cross-sectional view showing a modified form of cover assembly, according to the present invention, assembled to the brake disc rotor assembly in FIG. 2;

FIG. 6 is a view as in FIG. 5 of a further modified form of cover assembly; and

FIG. 7 is a view as in FIG. 2 and showing a still further modified form of cover assembly, according to the present invention.

### DETAILED DESCRIPTION OF THE PREFERRED EMBODIMENT

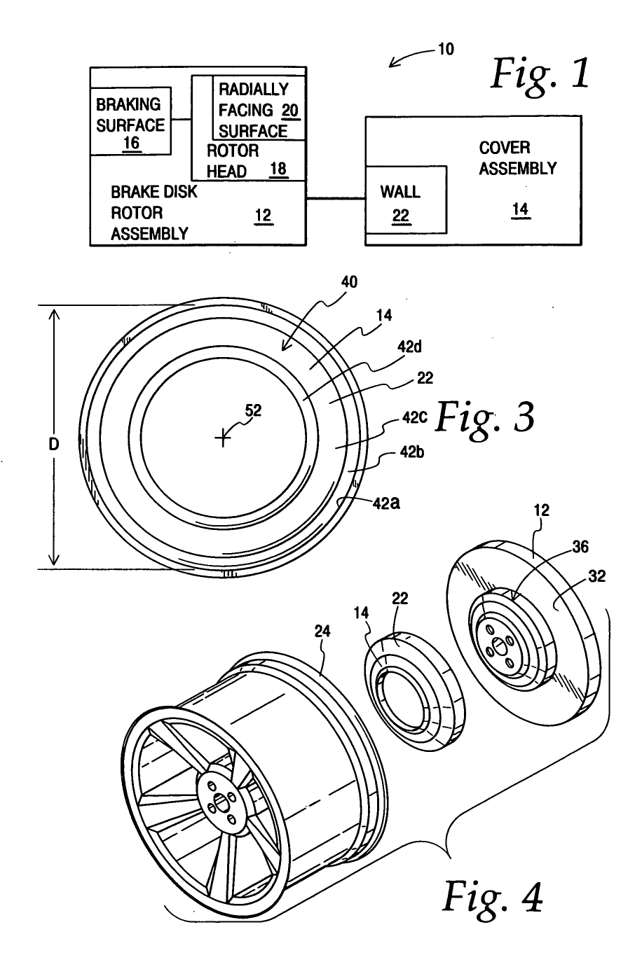

As shown in FIG. 1, the invention is directed to a vehicle wheel assembly at 10 consisting of a brake disc rotor assembly 12 and a cooperating cover assembly 14. The brake disc rotor assembly 12 may have a multitude of different constructions and typically will have a braking surface 16 that moves as a unit with a rotor head 18. The rotor head 18 has a radially outwardly facing surface 20. The radially facing surface 20 is typically made of metal and is prone to rusting. A wall 22 on the cover assembly 14 is situated to block viewing of at least a part of the radially facing surface 20 from a perspective looking parallel to an axis around which a wheel mounted operatively upon the brake disc rotor assembly 12 moves.

The vehicle wheel assembly 10 is shown in schematic form since it is intended by such a showing to encompass all different configurations of these basic components in the automotive industry. The components are shown schematically also since it is not critical to the present invention to understand specific detail of certain of these components.

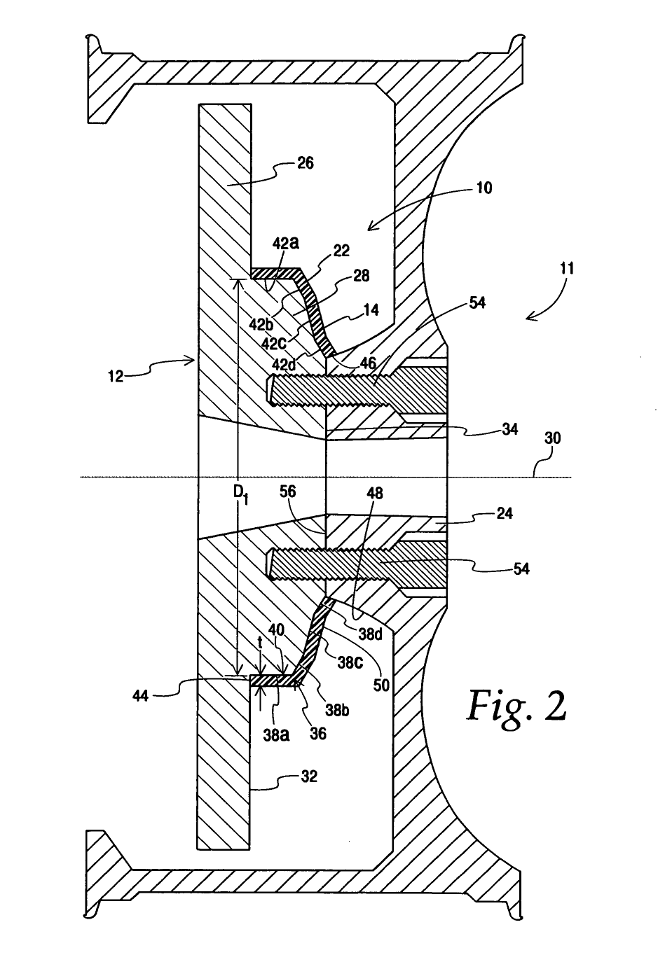

One specific, and exemplary, form of the vehicle wheel assembly 10 is shown in FIG. 2 with a wheel rim 24 operatively mounted thereupon. The brake disc rotor assembly 12 has an annular disc portion 26 and head 28 formed to move as one piece around an operating axis 30. The disc portion 26 has an axially outwardly facing braking surface 32. The head 28 has an axially outwardly facing wheel mounting surface 34 and a contoured radially outwardly facing surface 36 extending axially between the braking surface 32 and wheel mounting surface 34.

The radially facing surface 36 has a convex contour with angled, annular surface portions 38a, 38b, 38c, 38d that blend between the braking surface 32 and wheel mounting surface 34. The exact contour of the radially facing surface 36 is not critical to the present invention. However, typically this radially facing surface 36 has a contour/shape that makes it aesthetically pleasing to a viewer from an axial perspective. The convex contour is common to manufacturers' designs so that the radially facing surface 36 tends to resist accumulation of foreign matter thereon.

The cover assembly 14 has the aforementioned wall 22 that extends substantially fully axially between the braking surface 32 and wheel mounting surface 34.

As seen additionally in FIGS. 3 and 4, the wall 22 on the cover assembly 14 has a cup shape, opening axially inwardly. The wall 22 has an inside surface 40 that conforms closely to the contour of the radially facing surface 36 on the brake disc rotor assembly 12 over substantially the entirety of the extent of the radially facing surface 36 between the braking surface 16 and wheel mounting surface 34. More specifically, the inside surface 40 has angled surface portions 42a, 42b, 42c, 42d that closely conform to the surface portions 38a, 38b, 38c, 38d, consecutively, on the brake disc rotor assembly 12. The inner axial end 44 of the wall 22 abuts to the braking surface 32.

In this embodiment, the surface portions 42a, 42b, 42c, 42d facially contact the surfaces 38a, 38b, 38c, 38d, though this is not required.

The diameter D of the wall surface portion 42a may be slightly less than the diameter D1 of the surface portion 38a with the wall 22 in a relaxed state. Accordingly, by directing the wall 22 axially from an initially separated position to the assembled FIG. 2 position, the wall 22 radially compresses or is otherwise deformed radially outwardly at the surface portion 42a so that residual forces in the wall 22 cause the surface portion 42a on the wall 22 to surroundingly embrace the surface portion 38a.

To further secure the wall 22 in its assembled position, the outer axial end 46 of the wall 22 may be angled so that it is pressed against by a complementarily-angled surface portion 48 on the wheel rim 24. This interaction causes a force component to urge the wall 22 axially inwardly. This feature is not required for the wall 22 to be maintained effectively in its assembled position.

With the described arrangement, the cover 22 can be press/snap fit into its assembled position and maintained therein without requiring any fasteners extending into or through the wall 22.

The wall 22 may be constructed with an uninterrupted surface fully between the braking surface 32 and wheel mounting surface 34. In this embodiment, an outside surface 50 on the wall 22 has a contour that likewise corresponds to that of the inside surface 40 of the wall 22 and the radially facing surface 36 of the brake disc rotor assembly 12. With this construction, the wall 22 has a uniform thickness t between its axial ends 44, 46. The outside surface 50 can likewise be continuous and uninterrupted between the braking surface 32 and wheel mounting surface 34.

It is also contemplated that while the wall 22 is shown to fully and uninterruptedly cover the radially facing surface 36 between the braking surface 32 and wheel mounting surface 34, gaps and/or openings may be provided whereat the radially facing surface 36 is exposed. Since the wall 22 performs primarily an aesthetic function by reason of blocking viewing of the radially facing surface 36 from an axial perspective, it may be desired by the manufacturer of the cover assembly 14 to incorporate strategically placed gaps/openings that may leave exposed one or more discrete regions of the radially facing surface 36. As one example, a gap might be provided between the axial end 44 and the braking surface 32. One or more discrete openings may be provided at locations between the axial ends 44, 46. Further, a gap may be provided between the axial end 46 and the wheel 24.

To effect installation of the cover assembly 14, the wheel rim 24 is required to be separated from the brake disc rotor assembly 12. The center axis 52 of the cover assembly 14 is aligned with the axis 30, whereupon the wall 22 can be moved axially and thereby press/snap fit into the assembled position shown in FIG. 2. The wheel rim 24 can thereafter be mounted using conventional bolts 54. With the wheel rim 24 operatively mounted, an axially inwardly facing surface 56 thereon facially abuts to the wheel mounting surface 34.

The wall 22 can be made from different materials. While metal is contemplated, it is preferred that a non-metal material be utilized to form the wall 22. The non-metal material may be plastic or a composite, such as one that incorporates graphite.

One objective of designers of the cover assembly 22 may be to maintain the same visible contour of the radially facing surface 36 with the wall 22 assembled. In the embodiment shown in FIGS. 2-4, this is accomplished by having a uniform thickness wall 22 with both inside and outside surfaces 40, 50 closely conforming to the contour of the radially facing surface 36 over substantially its entire axial extent. Further, in this embodiment, there is shown intimate contact between the inside surface 40 and the radially facing surface 36 over the full axial extent of the radially facing surface 36. This, however, is not a requirement. It is, however, preferred that there be general conformity of at least one of the inside and outside surfaces 40, 50, and preferably the outside surface 50, over a majority of the axial extent of the radially facing surface 36.

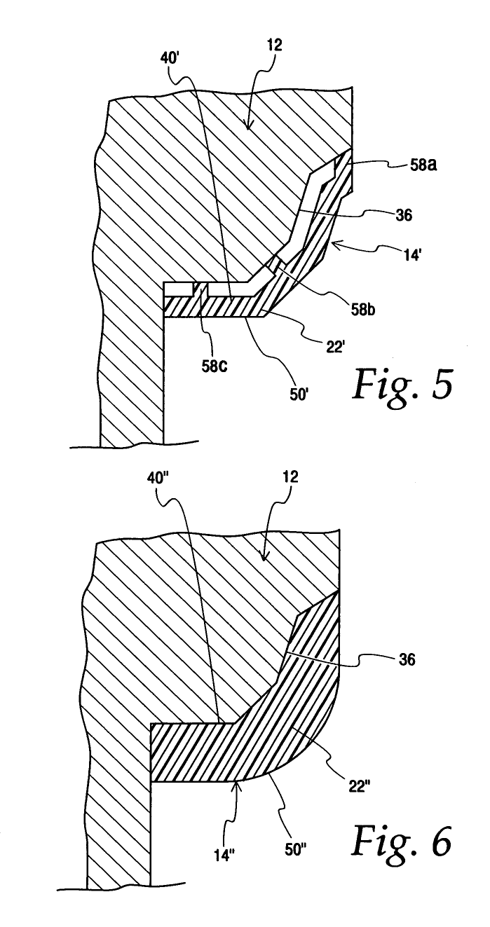

In an alternative form, as shown in FIG. 5, a modified form of the wall 22′, on a cover assembly 14′ for the brake disc rotor assembly 12, is shown to incorporate spacing elements 58a, 58b, 58c that engage the radially facing surface 36. In this embodiment, both of the inside and outside surfaces 40′, 50′, corresponding to the surfaces 40, 50, respectively, have general conformity to the radially facing surface 36. This arrangement also permits the press/snap fit connecting arrangement.

As shown in FIG. 6, a wall 22″, on a cover assembly 14″ for the brake disc rotor assembly 12, may be made with an inside surface 40″ that conforms to the radially facing surface 36, with an outside surface 50″ on the wall 22″ having a lesser degree of conformity to the radially facing surface 36.

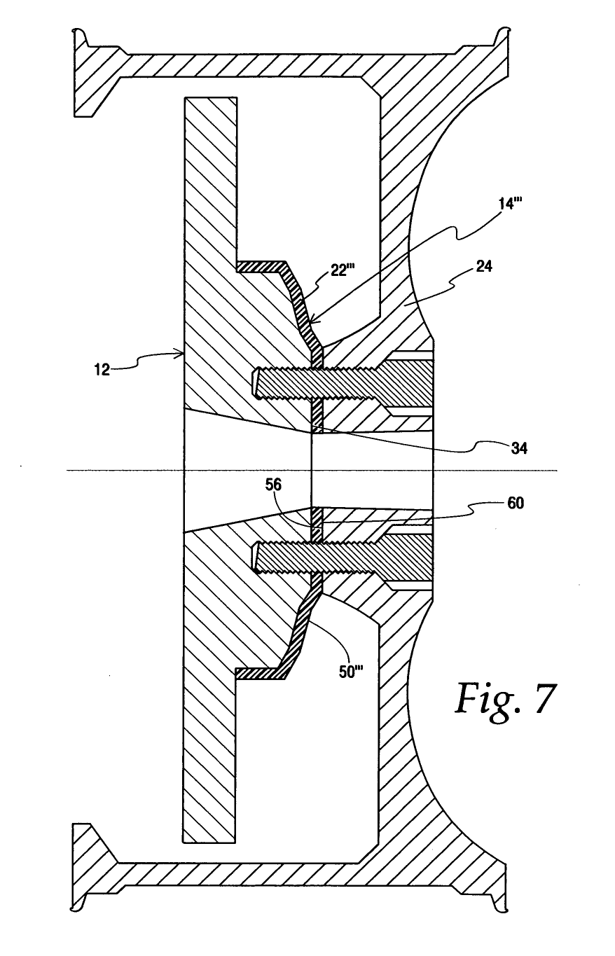

In a further modified form of cover assembly 14′″ for the brake disc rotor assembly 12, as shown in FIG. 7, a wall 22′″ has a portion 60 that radially overlies the wheel mounting surface 34 on the brake disc rotor assembly 12, whereas in the prior embodiments the cover assemblies 14, 14′, 14″ do not extend radially over the wheel mounting surface 34 to reside between the operatively mounted wheel rim 24 and wheel mounting surface 34. Accordingly, with the wheel 24 operatively mounted upon the brake disc rotor assembly 12, the wall portion 60 is captive between the wheel mounting surface 34 and the oppositely facing wheel surface 56.

Regardless of the form that is selected, the manufacturer of the cover assemblies 14, 14′, 14″, 14′″ may focus on different objectives. It may be desirable to generally maintain the contour of the radially facing surface 36 and simply to provide a more presentable outside surface 50, 50′, 50″, 50′″, and one that will not rust, to view.

Alternatively, the outside surface 50, 50′, 50″, 50′″ may be shaped substantially differently than the radially facing surface 36 and may incorporate aesthetic additions, such as openings, coloring, lettering, etc.

The cover assemblies 14, 14′, 14″, 14′″ lend themselves to being manufactured as by molding as a single piece that can be simply assembled at time of manufacture or by an end user as an after-market component.

Because the assembled cover assemblies 14, 14′, 14″, 14′″, as depicted, will not be exposed to forces in operation that tend to separate them from the brake disc rotor assembly 12, there may be no need for supplemental fastening structure, even on the exemplary embodiment shown in FIG. 2 that does not require a captive arrangement between the brake disc rotor assembly 12 and wheel 24.

The foregoing disclosure of specific embodiments is intended to be illustrative of the broad concepts comprehended by the invention.

1. A vehicle wheel assembly comprising:
a brake disc rotor assembly defining an operating axis for a wheel and comprising a braking surface, a rotor head, an axially facing wheel mounting surface against which a wheel rim is placed, and a radially facing surface axially outward of the braking surface; and
a cover assembly with a wall that conforms generally to the radially facing surface and situated to block viewing of at least a part of the radially facing surface from an axial perspective.

2. The vehicle wheel assembly according to claim 1 wherein the radially facing surface resides between the braking surface and wheel mounting surface.

3. The vehicle wheel assembly according to claim 2 wherein the cover assembly extends substantially fully axially between the braking surface and wheel mounting surface.

4. The vehicle wheel assembly according to claim 2 wherein the wall has an inside surface that abuts to the radially facing surface.

5. The vehicle wheel assembly according to claim 1 wherein the wall is press fit and frictionally maintained upon the brake disc rotor assembly.

6. The vehicle wheel assembly according to claim 1 wherein the wall is captively maintained between the brake disc rotor assembly and a wheel rim operatively mounted upon the brake disc rotor assembly.

7. The vehicle wheel assembly according to claim 1 wherein the radially facing surface has a contour between the braking surface and the wheel mounting surface, the wall has an inside surface, and the inside surface closely conforms to the contour of the radially facing surface over a majority of an axial extent of the radially facing surface between the braking surface and the wheel mounting surface.

8. The vehicle wheel assembly according to claim 7 wherein the inside surface closely conforms to the contour of the radially facing surface over substantially the entirety of the axial extent of the radially facing surface between the braking surface and the wheel mounting surface.

9. The vehicle wheel assembly according to claim 7 wherein the inside surface directly contacts the radially facing surface over a substantial axial extent of the radially facing surface.

10. The vehicle wheel assembly according to claim 1 wherein a portion of the cover assembly resides captively between the wheel mounting surface and a wheel rim mounted operatively upon the brake disc rotor assembly.

11. The vehicle wheel assembly according to claim 1 wherein the wall has a cup-shaped configuration opening axially inwardly.

12. The vehicle wheel assembly according to claim 1 wherein the cover assembly is formed in one piece.

13. The vehicle wheel assembly according to claim 1 wherein the wall is made from a non-metallic material.

14. The vehicle wheel assembly according to claim 1 in combination with a wheel rim operatively mounted upon the brake disc rotor assembly.

15. The vehicle wheel assembly according to claim 5 wherein there are no fasteners that extend into or through the wall to maintain the wall upon the brake disc assembly.

16. The vehicle wheel assembly according to claim 1 wherein the cover assembly substantially fully blocks viewing of the radially facing surface from an axial perspective.

17. The vehicle wheel assembly according to claim 7 wherein the wall has a substantially uniform radial thickness between the braking surface and the wheel mounting surface.

18. The vehicle wheel assembly according to claim 1 wherein the radially facing surface has a contour between the braking surface and the wheel mounting surface, the wall has radial inside and outside surfaces and the outside surface conforms to the contour of the radially facing surface over a majority of an axial extent of the radially facing surface between the braking surface and the wheel mounting surface.

19. A vehicle wheel assembly comprising:
a brake disc rotor assembly defining an operating axis for a wheel and comprising a braking surface, a rotor head, an axially facing wheel mounting surface against which a wheel rim is placed, and a radially facing surface axially outward of the braking surface; and
a cover assembly with a wall that is situated to block viewing of at least part of the radially facing surface from an axial perspective,
the cover assembly not extending radially over the wheel mounting surface whereby it would reside between the wheel mounting surface and a wheel rim operatively mounted upon the brake disc rotor assembly.

20. The vehicle wheel assembly according to claim 19 wherein the radially facing surface has a contour between the braking surface and the wheel mounting surface, the wall has an inside surface, and the inside surface closely conforms to the contour of the radially facing surface over a majority of an axial extent of the radially facing surface between the braking surface and the wheel mounting surface.
